(19) United States
(12) Patent Application Publication
(10) Pub. No.: US 2012/0090985 A1
(43) Pub. Date: Apr. 19, 2012

(54) NON-EQUILIBRIUM GLIDING ARC PLASMA SYSTEM FOR CO2 DISSOCIATION

(75) Inventors: ALEXANDER RABINOVICH, Cherry Hill, NJ (US); Thomas Nunnally, Philadelphia, PA (US); Alexander Fridman, Philadelphia, PA (US); Alexander F. Gutsol, San Ramon, CA (US)

(73) Assignee: DREXEL UNIVERSITY, Philadelphia, PA (US)

(21) Appl. No.: 13/251,379

(22) Filed: Oct. 3, 2011

Related U.S. Application Data
(60) Provisional application No. 61/388,861, filed on Oct. 1, 2010.

(51) Int. Cl. B01J 19/08

(52) U.S. Cl. 204/170; 204/164; 422/186.21; 422/186.04

(57) ABSTRACT

A reactor for dissociating carbon dioxide, and associated processes and systems, are described herein. In one example, a reactor is provided that is configured to use non-equilibrium gliding arc discharge plasma. In another example, the reactor uses a vortex flow pattern. A diaphragm may be used at the output of the reactor to control the vortex flow pattern. In some examples, the reactor may be configured to have varying upper and lower chamber sizes.

### CROSS REFERENCE TO RELATED APPLICATIONS

This Application claims the benefit of U.S. Provisional Patent Application No. 61/388,861, filed Oct. 1, 2010, which is incorporated by reference in its entirety.

### FIELD OF THE INVENTION

The invention is in the field of the chemical conversion of materials using plasma.

### BACKGROUND OF THE INVENTION

Carbon dioxide decomposition may be a useful process in several circumstances. For example, in reaction processes in which Carbon Dioxide is a byproduct, CO2 decomposition may be a useful way in which to reduce the amount of CO2 discharged into the atmosphere. Additionally, in locations in which CO2 is in abundance, for example, the surface of Mars, CO2 decomposition may be used to produce fuel for mobility.

The endothermic plasma chemical process of carbon dioxide decomposition can be presented by the summarizing formula:

$${CO}_{2} \to CO + \frac{1}{2} {O}_{2} , Δ H = 2.9 eV / mol . \qquad ( 1.1 )$$

The enthalpy of the process is fairly high and close to that corresponding to hydrogen production from water. The total decomposition process (1.1) starts with and is limited by CO₂ dissociation:

CO₂→CO+O,ΔH=5.5eV/mol (1.2),

and then ends up with O conversion into O₂ by means of either recombination or reaction with another CO₂ molecule.

CO₂ dissociation can be beneficial in a wide range of industrial applications, including treatment of power plant exhausts, synthesis of new transportation fuels, and even possible fuel production on Mars, where the atmosphere consists predominantly of CO₂. Besides that, carbon monoxide generated in plasma (1.1) may be reacted with water to produce hydrogen without spending significant or appreciable additional energy in the thermo-catalytic shift reaction:

CO₂+H₂O→CO₂,ΔH=−0.4eV/mol (1.3).

There is a need for an improved way to efficiently dissociate carbon dioxide.

### SUMMARY OF THE INVENTION

In some embodiments, systems and methods for dissociation of carbon dioxide using a non-equilibrium gliding arc plasma reactor are disclosed. The non-equilibrium gliding arc is used in a reactor having a vortex flow pattern. With an input of CO₂, the non-equilibrium, gliding arc plasma reactor at least partially decomposes CO₂ using reactions 1.1 or 1.2. The vortex, or in some embodiments, reverse vortex, flow pattern is configured to increase the stay time of the CO₂ reactant in the reactor, thus improving the efficiency of the reactor. In some embodiments, the input gas is not pure CO₂, thus resulting in other gaseous reactions that may create other products or byproducts. The presently disclosed subject matter is not limited to having pure CO₂ (including gas, liquid or solid) as the input nor is the subject matter limited to having only CO₂, O₂ and CO as the only possible outputs. For example, the reactor of the presently disclosed subject matter may have an additional carbon-based input stream, such as methane, that may produce CO and hydrogen gas (synthesis gas production).

In some embodiments, the reactor is primarily a cylindrical reactor with the body of the cylinder having two parts: an upper cylinder and a lower cylinder. The upper cylinder, in some embodiments, is configured to be at the high voltage potential and the lower cylinder, in some embodiments, is configured to be at the low (or ground) voltage potential. An insulator electrically isolates the upper and lower cylinders. It should be noted that the present subject matter should not be limited to a cylinder, as the other reactor configurations having similar properties will work as well.

Additionally, the use of the terms “upper” and “lower” merely describe the spatial relationship between the two parts and does not imply any limitation as to the orientation of the reactor with any other point of reference, such as the Earth. To help create the vortex flow, a diaphragm is situated on the output. The aperture of the diaphragm is adjusted based upon the flow rate of the input stream and may also be changed to adjust for possible efficiencies of the reactor. Additionally, the relative size of the upper and lower cylinders may be adjusted as well to, among other things, increase or decrease the recirculation flow of the reactants in the reactor.

These and other features of the subject matter are described below.

### BRIEF DESCRIPTION OF THE DRAWINGS

The foregoing summary, as well as the following detailed description of the subject matter is better understood when read in conjunction with the appended drawings. For the purposes of illustration, there is shown in the drawings exemplary embodiments; however, these embodiments are not limited to the specific methods and instrumentalities disclosed. In the drawings:

FIG. 1 is an exemplary illustration showing the creation of a gliding arc discharge;

FIG. 2 is an exemplary illustration of a cyclonic reactor illustrating a vortex flow as seen from the top to the bottom of the reactor;

FIG. 3 is an exemplary illustration showing a vortex flow having some reverse vortex flow;

FIG. 3a is an exemplary illustration of a reactor showing a reverse vortex flow pattern;

FIG. 4 is an illustration of an exemplary reactor for dissociating carbon dioxide;

FIG. 5 is an illustration of an alternate exemplary reactor for dissociating carbon dioxide; and

FIG. 6 is an illustration of an alternate exemplary reactor for dissociating carbon dioxide and for producing synthesis gas.

### DETAILED DESCRIPTION OF ILLUSTRATIVE EMBODIMENTS

Certain specific details are set forth in the following description and figures to provide a thorough understanding of various embodiments of the subject matter. Certain well-known details are not set forth in the following disclosure to avoid unnecessarily obscuring the various embodiments of the subject matter. Further, those of ordinary skill in the relevant art will understand that they can practice other embodiments of the subject matter without one or more of the details described below. Finally, while various methods are described with reference to steps and sequences in the following disclosure, the description as such is for providing a clear implementation of embodiments of the subject matter, and the steps and sequences of steps should not be taken as required to practice this subject matter.

The present invention may be understood more readily by reference to the following detailed description taken in connection with the accompanying figures and examples, which form a part of this disclosure. It is to be understood that this invention is not limited to the specific devices, methods, applications, conditions or parameters described and/or shown herein, and that the terminology used herein is for the purpose of describing particular embodiments by way of example only and is not intended to be limiting of the claimed invention.

Also, as used in the specification including the appended claims, the singular forms “a,” “an,” and “the” include the plural, and reference to a particular numerical value includes at least that particular value, unless the context clearly dictates otherwise. The term “plurality”, as used herein, means more than one. When a range of values is expressed, embodiments may include from the one particular value and/or to the other particular value. Similarly, when values are expressed as approximations, by use of the antecedent “about,” it will be understood that the particular value forms another embodiment. All ranges are inclusive and combinable.

It is to be appreciated that certain features of the invention which are, for clarity, described herein in the context of separate embodiments, may also be provided in combination in a single embodiment. Conversely, various features of the invention that are, for brevity, described in the context of a single embodiment, may also be provided separately or in any subcombination. Further, references to values stated in ranges include each and every value within that range.

Various embodiments of the present provide methods for dissociating carbon dioxide, each method comprising contacting a non-equilibrium, gliding arc discharge with carbon dioxide in a reactor, wherein some or all of the carbon dioxide is circulated within the reactor in a vortex flow pattern. In certain independent embodiments, at least 50 wt %, at least 60 wt %, at least 70 wt %, at least 80 wt %, at least 90 wt %, or at least 95 wt % of the carbon dioxide is circulated within the reactor in a vortex flow pattern. In other embodiments, the carbon dioxide is circulated in a reverse vortex flow pattern, while in still other embodiments, the carbon dioxide is circulated in a combination of vortex and reverse vortex flow patterns.

In other embodiments, the carbon dioxide is dissociated in the presence of at least one hydrocarbon, so as to produce a synthesis gas mixture, including those wherein the methods further comprise inputting a feedstock comprising carbon dioxide to a reactor chamber; and generating a gliding arc discharge plasma within said reactor.

In further embodiments of the methods and the reactors used in the methods, the reactors are conical or cylindrical in shape. In still further embodiments, each reactor comprises a reactor chamber having a high potential portion and a low potential portion, with the high potential portion being electrically isolated from the low potential portion; at least one orifice through which at least carbon dioxide can be input into the reactor, said at least one orifice directionally positioned for creating vortex flow within said reactor; a gap to facilitate a gliding arc discharge in conjunction with the inputting of the at least carbon dioxide; and an electrical power source having a high voltage potential in electrical communication with the high potential portion and a low voltage potential in electrical communication with the low potential portion; wherein the input, reactor chamber and electrical power source are configured to create a non-equilibrium gliding arc discharge within a vortex flow pattern. Other embodiments provide that the reactors further comprise an output orifice positioned at one end of the low potential portion of the chamber capable as acting as an output for the carbon dioxide and dissociated products therefrom and a diaphragm positioned at or proximate to the output orifice.

Other embodiments provide reactors and methods using same wherein the high potential portion of the reactor comprises a barrel-shaped electrode; and the low potential portion of the reactor comprises an electrically separate barrel-shaped electrode.

Still other embodiments provide reactors and methods wherein the high potential portion comprising barrel-shaped electrode has a volume at least about 10 vol %, at least about 25 vol % at least about 50 vol %, or at least about 10 vol %, larger than the low potential portion comprising the barrel-shaped electrode.

Whereas thus far, the chambers have been described in terms of a high and low potential portion, it should be appreciated that other embodiments provide reactors and methods wherein the potentials are reversed. That is, the portions of the reactors described above as high potential have electrical potentials that are lower than the potentials of the portions of the reactors described above as low potential, in each case, the terms high and low potential refer to the electrical potential with respect to one another.

Other embodiments provide methods wherein the at least one hydrocarbon is also input to the reactor, either in the feedstock comprising carbon dioxide or separately (for example, in separate feeds), or both. When so configured or used, the reactors or methods can be used to prepare synthesis gas. In certain embodiments, the reactors (and methods using same) comprise at least one input orifice at or proximate of the high potential portion of the chamber, said at least one input orifice capable of delivering at least one liquid hydrocarbon to the reaction chamber.

Plasmas, referred to as the “fourth state of matter,” are ionized gases having at least one electron that is not bound to an atom or molecule. In recent years, plasmas have become of significant interest to researchers in fields such as organic and polymer chemistry, fuel conversion, hydrogen production, environmental chemistry, biology, and medicine, among others. This is, in part, because plasmas offer several advantages over traditional chemical processes. For example, plasmas can generate much higher temperatures and energy densities than conventional chemical technologies; plasmas are able to produce very high concentrations of energetic and chemically active species; and plasma systems can operate far from thermodynamic equilibrium, providing extremely high concentrations of chemically active species while having a bulk temperature as low as room temperature.

Plasmas are generated by ionizing gases using any of a variety of ionization sources. Depending upon the ionization source and the extent of ionization, plasmas may be characterized as either thermal or non-thermal. Thermal and non-thermal plasmas can also be characterized by the temperature of their components. Thermal plasmas are in a state of thermal equilibrium, that is, the temperature of the free electrons, ions, and heavy neutral atoms are approximately the same. Non-thermal plasmas, or cold plasmas, are far from a state of thermal equilibrium; the temperature of the free electrons is much greater than the temperature of the ions and heavy neutral atoms within the plasma.

The initial generation of free electrons may vary depending upon the ionization source. With respect to both thermal and non-thermal ionization sources, electrons may be generated at the surface of the cathode due to a potential applied between the electrodes. In addition, thermal plasma ionization sources may also generate electrons at the surface of a cathode as a result of the high temperature of the cathode (thermionic emissions), or high electric fields near the surface of the cathode (field emissions), or as a result of ion and photon bombardment (secondary electron emission).

The energy from these free electrons may be transferred to additional plasma components, providing energy for additional ionization, excitation, dissociation, etc. With respect to non-thermal plasmas, the ionization process typically occurs by direct ionization through electron impact. Direct ionization occurs when an electron of high energy interacts with a valence electron of a neutral atom or molecule. If the energy of the electron is greater than the ionization potential of the valence electron, the valence electron escapes the electron cloud of the atom or molecule and becomes a free electron according to:

e⁻+A→A⁺+e⁻+e⁻.

As the charge of the ion increases, the energy required to remove an additional electron also increases. Thus, the energy required to remove an additional electron from A⁺ is greater than the energy required to remove the first electron from A to form A. A benefit of non-thermal plasmas is that because complete ionization does not occur, the power to the ionization source can be adjusted to increase or decrease ionization. This ability to adjust the ionization of the gas provides for a user to “tune” the plasma to their specific needs.

An exemplary thermal plasma ionization source is an arc discharge. Arc discharges have been otherwise used for applications such as metallurgy, metal welding and metal cutting and are known per se. Arc discharges are formed by the application of a potential to a cathode, and arc discharges are characterized by high current densities and low voltage drops. Factors relevant to these characteristics are the usually short distance between the electrodes (typically a few millimeters) and the mostly inert materials of the electrodes (typically, carbon, tungsten, zirconium, silver, etc). In the case of arc discharges the majority of electrons generated on the cathode surface are formed by intensive thermionic emission. Because of this intense generation of electrons at the cathode, current at the cathode is high, which leads to Joule heating and increased temperatures of the cathodes. Such high temperatures can result in evaporation and erosion of the cathode. The anode in arc discharges may be either an electrode having a composition identical or similar to the cathode or it may be another conductive material. For example, the anode in arc discharges used in metal welding or cutting is the actual metal to be welded or cut. Typical values for parameters of thermal arc discharges can be seen in Table 1:

TABLE 1
Arc Discharge Parameters

| Parameters of a Thermal Arc Discharge | Typical Values |
|---|---|
| Gas Pressure | 0.1 to 100 atm |
| Arc Current | 10 A to 30 kA |
| Cathode Current Density | 10⁴ to 10⁷ A/cm² |
| Voltage | 10 to 100 V |
| Power per unit length | ~1 kW/cm |
| Electron Density | 10¹⁵ to 10¹⁹ cm⁻³ |
| Gas Temperature | 1 to 10 eV |
| Electron Temperature | 1 to 10 eV |

Although thermal plasmas are capable of delivering extremely high powers, they have several drawbacks. In addition to the electrode erosion problems discussed above, thermal plasmas do not allow for adjusting the amount of ionization, they operate at extremely high temperatures, and they lack energy efficiency.

Non-thermal plasma ionization sources have alleviated some of the above-mentioned problems. Exemplary ionization sources for non-thermal plasmas include glow discharges, dielectric barrier discharges, and gliding arc discharges, among others. In contrast to thermal plasmas, non-thermal plasmas provide for high selectivity, high energy efficiencies, and low operating temperatures. In many non-thermal plasma systems, electron temperatures are about 10,000 K while the bulk gas temperature may be as cool as room temperature.

A glow discharge is a plasma source that generates a non-equilibrium plasma between two electrodes under a direct current. There are several types of glow discharges; a common one is in the “neon” lights. This glow discharge is established in a long tube with a potential difference applied between an anode at one end of the tube and a cathode at the other end. The tube is filled usually with an inert gas often under low pressure. Due to the potential difference between the electrodes, electrons are emitted from the cathode and accelerate toward the anode. The electrons collide with gas atoms in the tube and form excited species. These excited species decay to lower energy levels through the emission of light (i.e., glow). The ionized species generated by the collision of electrons with gas atoms travel toward the cathode and release secondary electrons, which are then accelerated toward the anode. This generation of electrons, referred to as secondary emission, is in contrast to the intensive formation of electrons at the surface of the cathode in arcs due to thermionic emission. Typical parameters of a glow discharge as described above are shown in Table 2:

TABLE 2
Parameters of Glow Discharge

| Parameters of a Glow Discharge | Typical Values |
|---|---|
| Discharge Tube Radius | 0.3 to 3 cm |
| Discharge Tube Length | 10 to 100 cm |
| Plasma Volume | About 100 cm³ |
| Gas Pressure | 0.03 to 30 Torr |
| Voltage Between Electrodes | 100 to 1000 V |
| Electrode Current | 10⁻⁴ to 0.5 A |
| Power Level | ~100 W |

Dielectric barrier discharge (DBD) may be generated using an alternating current at a frequency of from about 0.5 kHz to about 500 kHz between a high voltage electrode and a ground electrode. In addition, one or more dielectric barriers are placed between the electrodes. DBDs have been employed for over a century and have been used for the generation of ozone in the purification of water, polymer treatment (to promote wettability, printability, adhesion), and for pollution control. Dielectric barrier in DBDs prevents spark formation by limiting current between the electrodes.

Several materials can be utilized for the dielectric barrier. These include glass, quartz, and ceramics, among others. The clearance between the discharge gaps is typically between about 0.1 mm and several centimeters. The required voltage applied to the high voltage electrode varies depending upon the pressure and the clearance between the discharge gaps. For a DBD at atmospheric pressure and a few millimeters between the gaps, the voltage required to generate a plasma is typically about 10 kV. In certain embodiments, the ground electrode of the DBD may be an external conductive object, such as a human body. This is known as floating-electrode DBD (FE-DBD). FE-DBD has recently been utilized in medical applications.

All variety of plasma-chemical systems is traditionally divided into two major classes: thermal and non-thermal ones, characterized by their specific advantages and disadvantages [10]. Thermal plasma (usually arcs or Radio Frequency ICP-discharges) is associated with Joule heating, thermal ionization and enable to deliver high power (to over 50 Megawatts per unit) at high operating pressures. However, low excitation selectivity, very high gas temperature, serious quenching requirements and electrode problems result in limited energy efficiency and applicability of thermal plasma sources.

Non-thermal plasma (of low pressure glow, RF-, and microwave discharges) offers high selectivity and energy efficiency of plasma chemical reactions; it is able to operate effectively at low temperatures and without any special quenching. However, operating pressures and power levels of the non-thermal discharges are usually limited, which makes them not practical enough to render sufficient degrees of conversion and high production rates. Conventional thermal and non-thermal discharges cannot provide simultaneously a high level of non-equilibrium, high electron temperature, high electron density, and high power, whereas most prospective plasma chemical applications require both a high power for efficient reactor productivity and a high degree of non-equilibrium to support selectively chemical processes.

One of the critical challenges of modern plasma chemistry is to unite the advantages of thermal and non-thermal plasma systems by developing powerful and high-pressure discharges generating non-equilibrium cold plasma, which can be applied in particular for large scale exhaust gas cleaning, pollution control, fuel conversion, hydrogen production and surface treatment. One of the possible ways to create such hybrid plasma is to use the transient type of arc—the gliding arc (GA) discharge. This periodic discharge evolves during a cycle from arc to strongly non-equilibrium discharge with still relatively high level of electron density.

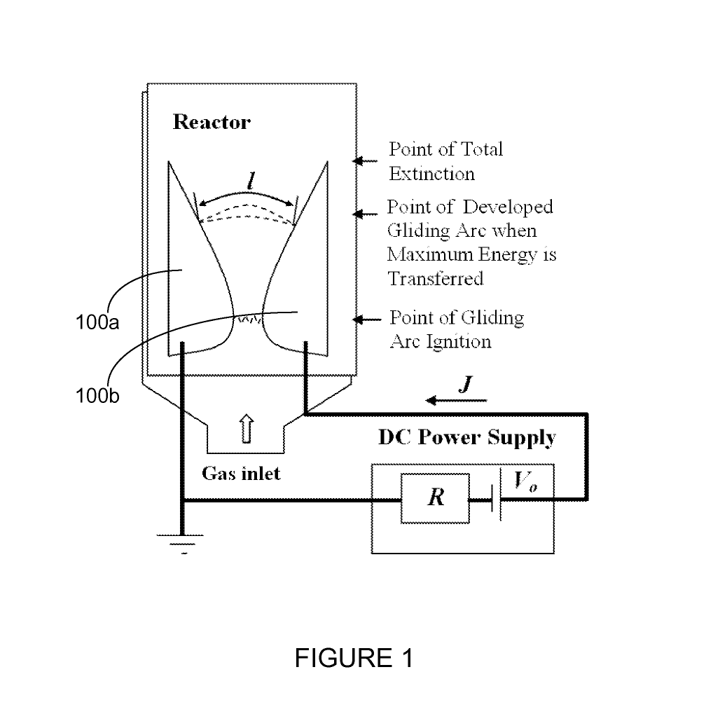

FIG. 1 is illustrative of a gliding arc discharge. A conventional gliding arc starts in a narrow gap “1” between two or more diverging electrodes 100a, 100b in a gas flow. When the electric field in this gap reaches a breakdown potential (based upon the distance between the gap) in air, the arc current increases very fast and the voltage on the arc drops. If the gas flow is strong enough, it forces the arc to move along the diverging electrodes and to elongate. The growing arc demands more power to sustain itself. At the moment when its resistance becomes equal to the total external resistance, the discharge consumes one-half of the power delivered by the source. This is the maximum power that can be transferred to the arc from the constant-voltage power supply.

Next, the length continues increasing, but the supplied power is insufficient to balance energy losses of the thermal plasma to the surrounding gas. The arc cools down and either extinguishes or changes ionization mechanism to non-thermal one—if electric field is sufficient for that. The non-thermal plasma channel formed after the “equilibrium/non-equilibrium” transition keeps growing until extinguishing anyway closing a cycle. The next cycle starts immediately after the voltage reaches the breakdown value, usually just after the fading of the previous arc. A typical repetition rate of the arc is in the range of 10 Hz to 100 Hz and changes with the gas flow rate: the higher is the flow rate, the higher is the frequency. The gliding arcs can be arranged, depending on current and flow rate, as completely thermal (at high currents), completely non-thermal (lowest currents), and as transitional discharge (at intermediate currents). In some uses, the transitional regime may be the most practical one because it is mainly non-thermal though still powerful and remembering its “quasi-thermal past” (“the memory effect”).

The term “gliding arc” is used in the present subject matter as is understood by those skilled in the art. It should be understood that a plasma discharge in the present subject matter may be generated in various ways, for example, glow discharge. In a reactor implementing a glow discharge, a cathode current may be controlled mostly by the secondary electron emission, as occurs in glow discharge, instead of thermionic emission, as occurs in electrical arcs.

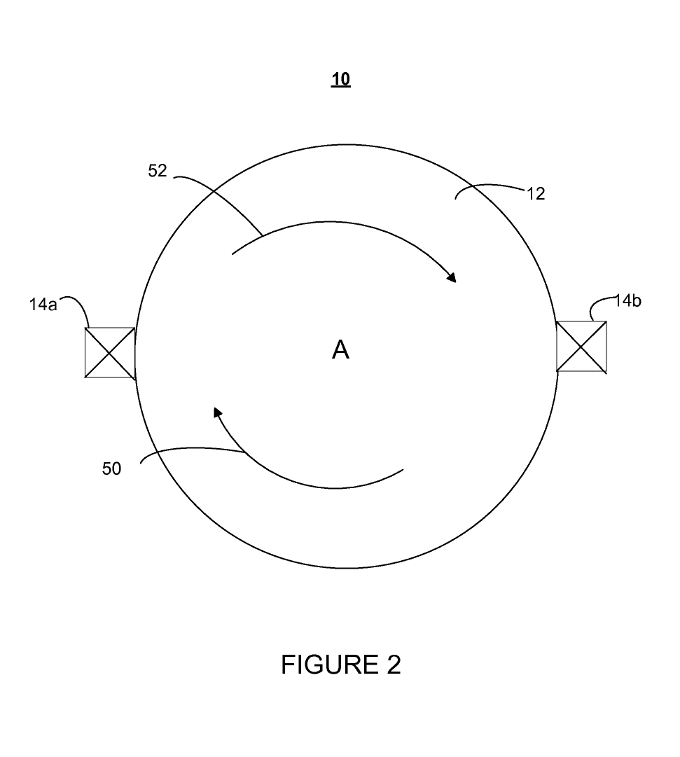

Vortex flow, as described herein, may be shown in reference to FIG. 2, which illustrates the rotation of the flow pattern. FIG. 2 illustrates the rotation of the fluids inside reaction chamber 12. Reactor 10 reaction chamber 12 has axis “A” that extends from the top (not shown), such as top 34 of reactor 10 to the bottom (not shown), such as bottom 36, of reactor 10. In the present embodiment, a rotational flow is generated by nozzles (or orifices) 14a and 14b introducing input fluid (not shown) into reaction chamber 12 tangential to axis “A”. A general flow pattern is caused whereby the fluids in the reactor rotate about axis “A”, shown by exemplary fluid flows 50 and 52.

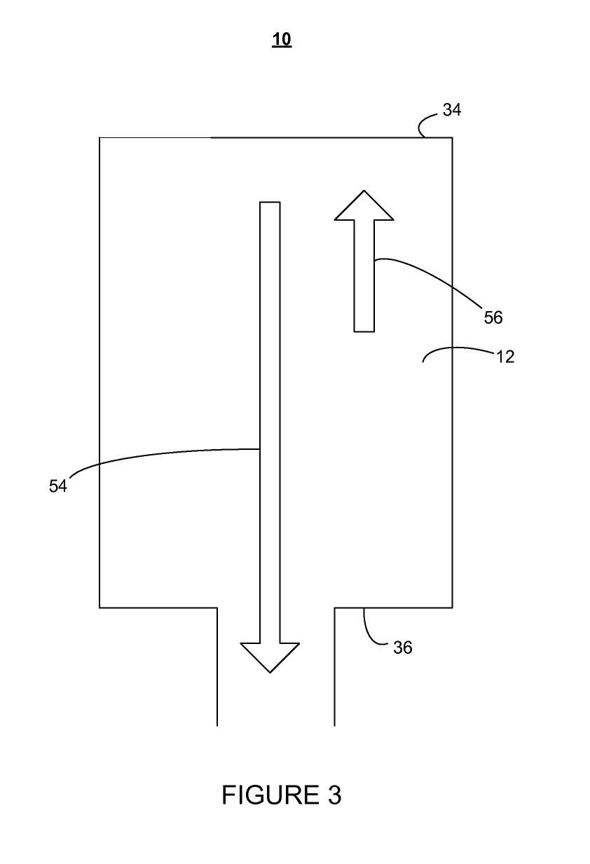

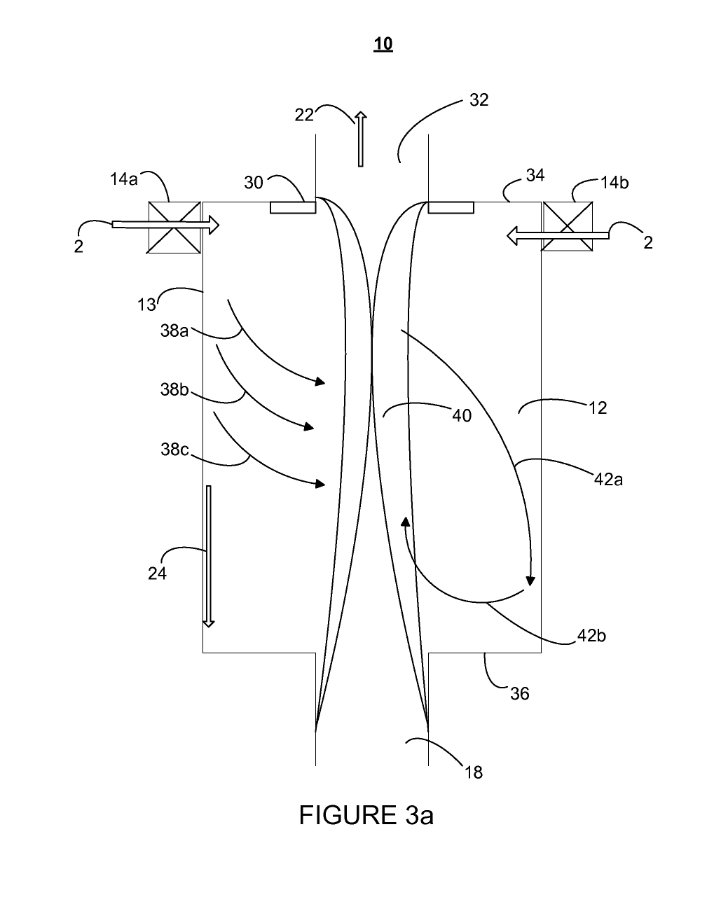

FIG. 3 is provided to illustrate a reverse vortex flow pattern. Reactor 10 has top 34 and bottom 36. Reaction chamber 12 has two general flow patterns, the flow pattern illustrated in FIG. 2, above, and exemplary flows 54 and 56. It should be understood that these flow patterns are one component of the flow of reactants and/or reaction products in reaction chamber 12, with the rotational flow pattern being the other component. Generally in reactor 10, components flow in a downward motion from top 34 to bottom 36 near the center of reactor 10.

For example, FIG. 3a illustrates a reverse vortex flow pattern. In FIG. 3a, a schematic view of an exemplary reactor, reactor 10, is illustrated. It should be noted that the shape and size of reactor 10 may vary. For example, reactor 10 may be generally conical or cylindrical in shape. Reactor 10 includes reaction chamber 12. At or near top 34 of reactor 10, there is a swirl generator, that can be formed by one or more nozzles 14a, 14b, that cause rotation of the fluids in reaction chamber 12. Rotation of the fluids in reaction chamber 12 may be caused by various ways. In the present embodiment, nozzles 14a and 14b may be tangential nozzles that introduce input fluid 2 into reaction chamber 12 tangentially. This present embodiment is for illustrative purposes only, as the rotation may be caused by other means, such as baffles inside of reaction chamber 12. Further, in some embodiments, input fluid 2 may be introduced into reaction chamber 12 at or near sonic velocity having mostly the tangential component of the velocity vector.

It should also be understood that, although the reactor 10 of FIG. 3a is shown as having top 34 and bottom 36, reactor 10 may be arbitrarily oriented in space, and the significance of the spatial orientation of top 34 and bottom 36 are merely to provide reference points to illustrate the exemplary embodiment of reactor 10.

Referring back to FIG. 3a, nozzles 14a, 14b that help to generate a rotation of the fluids in reactor 10 may be located about a circumference of vortex reactor 10 and are preferably spaced evenly about the circumference. Although two nozzles, 14a, 14b, are illustrated in FIG. 3a, it should be understood that this configuration is an exemplary configuration and that reactor 10 may have one nozzle or more than two nozzles, depending upon the configuration. In other embodiments, additional nozzles, not shown, may be placed in various locations on reactor 10. Additionally, it should be understood that one or more nozzles may be used to introduce one or more input fluids into reaction chamber 12. In the present embodiment, reactor 10 has input fluid 2 and two output streams, output stream 22 and output stream 24.

Input fluid 2 is introduced to reaction chamber 12 via nozzles 14a, 14b, the outputs of which are preferably oriented tangential relative to wall 13 of reaction chamber 12, as shown by FIG. 2, which is a topside illustration of reactor 10. As shown in FIG. 2, reactor 10 has nozzles 14a and 14b. Input fluid 2 exits nozzles 14a and 14b and enters reaction chamber 12 in a generally tangential direction about an axis, such as axis “A” as illustrated in FIG. 2.

By introducing input fluid 2 in this manner, as discussed above, a rotational force is imparted upon the fluids in reaction chamber 12, thus causing a rotation of the fluids in reaction chamber 12 in a clockwise direction in this embodiment. Thus, the velocity at which input fluid 2 enters reaction chamber 12 effects the rotational speed of the contents in reaction chamber 12. It should be noted that the input direction may be in a direction reverse to that shown in FIG. 2. Further, it should be understood that one or more nozzles may be configured to introduce the input fluid in a direction dissimilar to other nozzles.

Referring back to FIG. 3a, in an embodiment of the present subject matter, flange (or diaphragm) 30 and circular opening 32, located substantially at the center of flange 30, assist to form a vortex flow. In the present embodiment, the vortex flow is a reverse vortex flow, though it should be understood that the vortex flow may be a forward vortex flow.

Referring back to FIG. 3a, opening 32 in flange 30 is preferably circular, but may be other shapes such as pentagonal or octagonal. The size of circular opening 32 may be varied to configure reactor 10 for various flow patterns in reaction chamber 12. In this present embodiment, for example, the diameter of opening 32 in flange 30 may be from approximately 50% up to 95% of the diameter of reaction chamber 12 to form the reverse vortex flow.

The diameter of opening 32 may also be configured to establish, or prevent, a recirculation zone from forming. Reactor 10 may be configured to provide a way in which relatively hot fluids flowing from plasma region 40 may exchange a portion of their heat with fluids flowing to plasma region 40. For example, exemplary fluids 38a-c, which are flowing generally towards plasma region 40 receive heat from exemplary fluid 42a, which is flowing from plasma region 40. Exemplary fluid 42a, after exchanging heat with exemplary fluids 38a-c, may than flow back to plasma region 40, as shown by exemplary fluid 42b. Thus, a portion of the reaction heat generated in plasma region 40 and a portion of fluids in reaction chamber 12 recirculate within reactor 10. In one embodiment, if a recirculation zone is desired, the diameter of opening 32 in flange 30 may be approximately 10% up to 75% of the diameter of reaction chamber 12.

As discussed above, reverse vortex flow as used herein means that the vortex flow has axial motion initially caused by nozzles 14a and 14b along wall 13 of the chamber and then the flow turns back and moves along the axis to the “open” end of the chamber towards opening 32. An example in nature of this flow pattern may be similar to the flow inside a dust separation cyclone, or inside a natural tornado. Input fluid 2 travels in a circular motion, traveling in a downward and inward direction towards plasma region 40, as shown by exemplary fluids 38a-c.

A reverse vortex flow in reaction chamber 12 causes the contents of reactor 10 in reaction chamber 12 to rotate around plasma region 40, while output stream 22 travels in a direction upwards from the bottom of reactor 10 to opening 32. Along with other benefits that may not be explicitly disclosed herein, the rotation may provide necessary time for the heating of the contents flowing to and in the relatively hot plasma region 40 as the contents move downwardly around plasma region 40. Another benefit of the rotation may be that the reverse vortex flow may increase the residence time of reactants and products inside reaction chamber 12 while keeping the flow speed relatively high.

A vortex flow, such as the reverse-vortex flow described in FIG. 3a, may provide for several benefits, some of which may not be explicitly described herein. For example, the flow may cause one two or more zones inside chamber 12, one being plasma region 40, the other being the remaining volume of reaction chamber 12. For example, in the present subject matter, a temperature differential is established between plasma region 40 to wall 13 of reactor 10. A central axis in plasma region 40 may have the highest temperature in reaction chamber 12, and as the radial distance from that central axis increases to wall 13, the temperature may decrease.

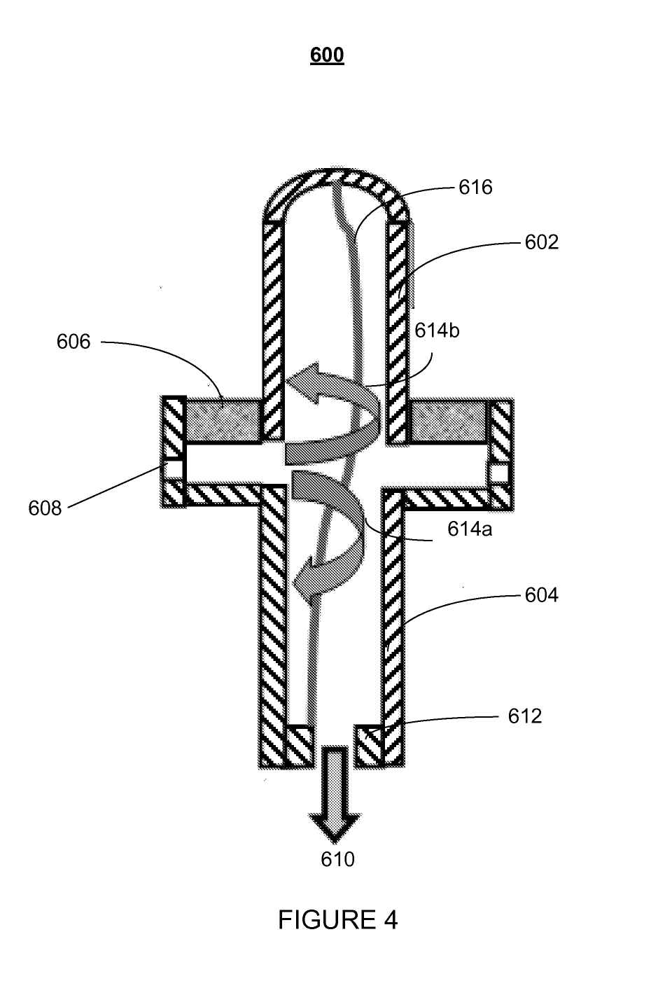

FIG. 4 illustrates an exemplary reactor using non-equilibrium gliding arc discharge to dissociate CO₂. Reactor 600 has an upper chamber 602 which is the high voltage electrode and lower chamber 604 which is the low potential (ground in some examples) electrode. Upper chamber 602 is electrically isolated from lower chamber 604 by insulator 606. CO₂, and/or other inputs, are introduced into reactor 600 at tangential inlet 608. The reactants circulate through reactor 600 in a generally vortex flow pattern caused by diaphragm 612. The flow patterns are illustrated as flow patterns 614a and 614b. The reactants in flow pattern 614b migrate to the top of upper chamber 602 in a generally circular pattern, interacting with plasma 616.

In an exemplary embodiment, incoming gas enters the cylindrical reactor through tangential inlet holes. Gliding arc discharge starts in the gap between 2 electrodes and stretches both ways (upward and downward) by incoming gas vortex. Incoming gas (CO₂) splits into 2 flows (upward and downward). The ratio of these flows depends on diameters of both electrodes and diaphragm's diameter. Both high voltage and ground electrodes have extended length to maximize the residence time of CO₂ contact with plasma arc and thus to increase CO₂ dissociation efficiency. Restricted exit of ground electrode (diaphragm) serves the purpose of particular flow formation inside the reactor 600. The reaction products and byproducts exit reactor 600 through output orifice 610.

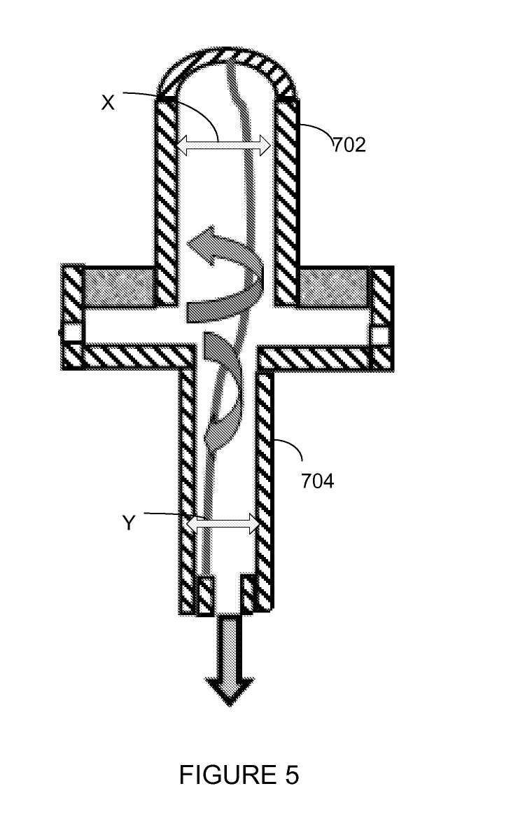

FIG. 5 illustrates a reactor for the dissociation of CO₂ in which the upper and lower chambers of the reactor are different sizes. Reactor 700 has upper, high potential chamber comprises an electrode 702 having inner diameter “X” and lower, low potential chamber comprises an electrode 704 having inner diameter “Y”, with “Y” being smaller than “X”. In this design the volume of high voltage electrode is at least about 10 vol %, at least about 25 vol %, at least about 50 vol %, or at least about 100 vol % larger than volume of ground electrode. By changing (e.g., decreasing) the inner diameter of ground electrode it is possible to significantly increase CO₂ flow recirculation and to increase CO₂ dissociation efficiency.

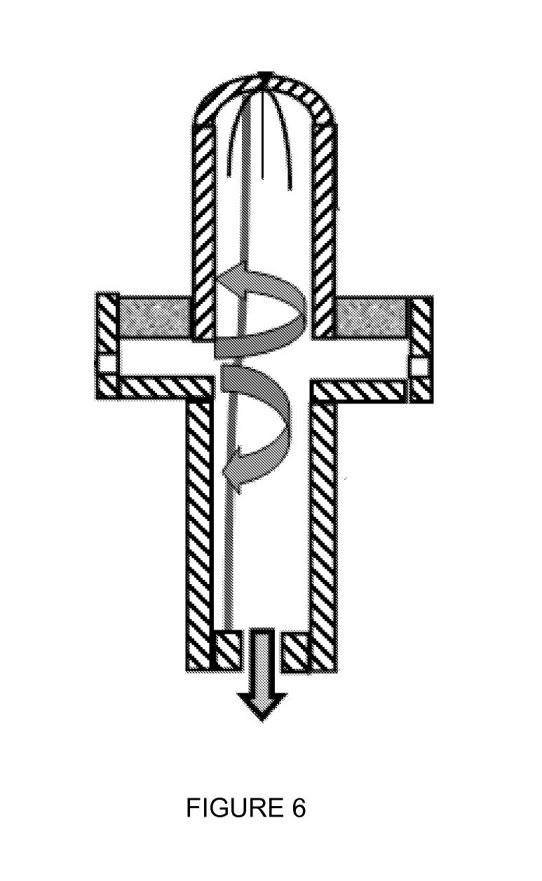

FIG. 6 illustrates a reactor that, in conjunction with dissociating CO₂, may also be used to reform hydrocarbons and produce synthesis gas. In this example the following reaction occurs (using methane as example):

CH₄+CO₂→2CO+2H₂ΔH=2.6eV/mol

Liquid or gaseous hydrocarbons could be introduced into plasma zone from the top of high potential electrode or tangentially in mixture with CO2. This so called dry reforming process is similar to steam reforming of methane, although it is more endothermic. At the same time in contrast to the steam reforming, the dry reforming can be more efficient in case of gaseous hydrocarbons due to complete gas phase nature of reaction.

This process consumes CO₂ and produces synthesis gas, therefore it can be attractive for environmental control. Produced synthesis gas could be used for liquid fuel production or power generation.

While the embodiments have been described in connection with the preferred embodiments of the various figures, it is to be understood that other similar embodiments may be used or modifications and additions may be made to the described embodiment for performing the same function without deviating therefrom. Therefore, the disclosed embodiments should not be limited to any single embodiment but rather should be construed in breadth and scope in accordance with the appended claims.

What is claimed:

1. A method for dissociating carbon dioxide, comprising contacting a non-equilibrium, gliding arc discharge with carbon dioxide in a reactor, wherein at least a portion of the carbon dioxide is circulated within the reactor in a vortex flow pattern.

2. The method of claim 1, wherein at least a portion of the carbon dioxide circulated within the reactor in a reverse vortex flow pattern.

3. The method of claim 1, wherein the carbon dioxide is dissociated in the presence of at least one hydrocarbon, so as to produce a synthesis gas mixture.

4. The method of claim 1, wherein the reactor is conical or cylindrical in shape.

5. The method of claim 1, wherein the reactor comprises.
a reactor chamber having a high potential portion and a low potential portion, with the high potential portion being electrically isolated from the low potential portion;
at least one orifice through which at least carbon dioxide can be input into the reactor, said at least one orifice directionally positioned for creating vortex flow within said reactor;
a gap to facilitate a gliding arc discharge in conjunction with the inputting of the at least carbon dioxide;
an output orifice positioned at one end of the low potential portion of the chamber capable as acting as an output for the carbon dioxide and dissociated products therefrom;
a diaphragm positioned at or proximate to the output orifice; and
an electrical power source having a high voltage potential in electrical communication with the high potential portion and a low voltage potential in electrical communication with the low potential portion;
wherein the input, reactor chamber and electrical power source are configured to create a non-equilibrium gliding arc discharge within a vortex flow pattern; said method comprising
inputting a feedstock comprising carbon dioxide to said reactor chamber; and
generating a gliding arc discharge plasma within said reactor.

6. The method of claim 5, wherein:
the high potential portion of the reactor comprises a barrel-shaped electrode; and
the low potential portion of the reactor comprises an electrically separate barrel-shaped electrode.

7. The method of claim 6, wherein the high potential portion comprising barrel-shaped electrode has a volume at least about 25 vol % larger than the low potential portion comprising the barrel-shaped electrode.

8. The method of any of claims 5-7 wherein the potentials of the reaction chamber portions are reversed.

9. The method of any one of claims 5-8 wherein the at least one hydrocarbon is also input to the reactor, either within the feedstock comprising carbon dioxide, separate from the feedstock comprising carbon dioxide, or both.

10. A reactor for dissociating carbon dioxide, comprising:
a reactor chamber having a high potential portion and a low potential portion, with the high potential portion being electrically isolated from the low potential portion;
at least one orifice through which at least carbon dioxide can be input into the reactor, said at least one orifice directionally positioned for creating vortex flow within said reactor;
a gap to facilitate a gliding arc discharge in conjunction with the inputting of the at least carbon dioxide; and
an electrical power source having a high voltage potential in electrical communication with the high potential portion and a low voltage potential in electrical communication with the low potential portion;
wherein the input, reactor chamber and electrical power source are configured to create a non-equilibrium gliding arc discharge using a vortex flow pattern.

11. The reactor of claim 10, further comprising an output orifice positioned at one end of the low potential portion of the chamber capable as acting as an output for the carbon dioxide and dissociated products therefrom and a diaphragm positioned at or proximate to the output orifice.

12. A reactor for dissociating carbon dioxide, comprising:
a high potential barrel-shaped electrode;
a low potential barrel-shaped electrode;
at least one orifice through which at least carbon dioxide can be input into the reactor, said orifice directionally positioned for creating vortex flow within said reactor;
a gap to facilitate a gliding arc discharge in conjunction with the inputting of the at least carbon dioxide; and
a diaphragm positioned at or proximate to the end of the low potential barrel-shaped electrode.

13. The reactor of claim 12, wherein the high potential barrel-shaped electrode has a volume at least 25 vol % larger than the low potential barrel-shaped electrode.

14. The reactor of claim 12 further comprising at least one input orifice at or proximate of the high potential portion of the chamber, said at least one input orifice capable of delivering at least one liquid hydrocarbon to the reaction chamber.

15. A reactor for producing synthesis gas, comprising
a high potential extended electrode;
a liquid input for receiving liquid hydrocarbons at or proximate to the top of the high potential extended electrode; and
a gas input for receiving carbon dioxide or a mixture of carbon dioxide and gaseous hydrocarbons, the gas input characterized as comprising tangential orifices for creating vortex flow.
